(19) United States
(12) Patent Application Publication
(10) Pub. No.: US 2021/0225381 A1
(43) Pub. Date: Jul. 22, 2021

(54) INFORMATION PROCESSING DEVICE, INFORMATION PROCESSING METHOD, AND PROGRAM

(71) Applicant: SONY CORPORATION, TOKYO (JP)

(72) Inventor: HIDEO NAGASAKA, KANAGAWA (JP)

(21) Appl. No.: 16/077,811

(22) PCT Filed: Nov. 16, 2016
(86) PCT No.: PCT/JP2016/083915

§ 371 Date: Aug. 14, 2018

(30) Foreign Application Priority Data
Mar. 4, 2016 (JP) 2016-041747

(51) Int. Cl. G10L 17/22; G06F 3/14; G06F 40/30

(52) U.S. Cl. CPC G10L 17/22; G06Q 30/0613; G06F 40/30; G06F 3/14

(57) ABSTRACT

[Object] A technology that enables the user to easily recognize a situation to which output information provided to the user corresponds is desired to be provided. [Solution] Provided is an information processing device including: a record control unit configured, in a case where information regarding a situation of a user is detected, to associate identification information with a predetermined section of conversation information with the user, and control recording of the identification information; a transmission control unit configured to control transmission of the information regarding the situation of the user, and the identification information; and an output control unit configured, in a case where an answer to the information regarding the situation of the user, and the identification information are acquired, to control output of the predetermined section associated with the identification information, and output information corresponding to the answer.

### TECHNICAL FIELD

The present disclosure relates to an information processing device, an information processing method, and a program.

### BACKGROUND ART

In recent years, various systems are known as systems for changing a situation of a user (e.g. systems for making an answer to a question of the user). For example, there is disclosed a technology in which an intermediary that mediates between a user and an answerer provides a question of the user to a plurality of answerers, selects an appropriate answer from among answers obtained from the plurality of respective answerers, and provides output information to the user on the basis of the selected answer (e.g. refer to Patent Literature 1).

In addition, there is disclosed a technology in which an intermediate center searches answers pre-registered in a database, on the basis of a question of a user, and generates an answerer list on the basis of the question of the user in a case where an answer is not obtained from the database (e.g. refer to Patent Literature 2). In this technology, an answerer with a higher degree of matching to the question of the user is positioned at a higher place in the answerer list, and answerers receive the question of the user in order from the answerer positioned at the higher place in the answerer list.

### CITATION LIST

### Patent Literature

Patent Literature 1: JP 2002-74064 A

Patent Literature 2: JP 2004-192521 A

### DISCLOSURE OF INVENTION

### Technical Problem

Nevertheless, times required until answers are obtained from the answerers are not uniform. Thus, there is a possibility that, when output information corresponding to an answer from an answerer is provided to the user, the user cannot easily recognize to which situation the output information corresponds. In view of the foregoing, a technology that enables the user to easily recognize a situation to which output information provided to the user corresponds is desired to be provided.

### Solution to Problem

According to the present disclosure, there is provided an information processing device including: a record control unit configured, in a case where information regarding a situation of a user is detected, to associate identification information with a predetermined section of conversation information with the user, and control recording of the identification information and the predetermined section; a transmission control unit configured to control transmission of the information regarding the situation of the user, and the identification information; and an output control unit configured, in a case where an answer to the information regarding the situation of the user, and the identification information are acquired, to control output of the predetermined section associated with the identification information, and output information corresponding to the answer.

According to the present disclosure, there is provided an information processing method including: associating identification information with a predetermined section of conversation information with a user, and controlling recording of the identification information and the predetermined section in a case where information regarding a situation of the user is detected; controlling transmission of the information regarding the situation of the user, and the identification information; and controlling output of the predetermined section associated with the identification information, and output information corresponding to an answer to the information regarding the situation of the user, in a case where the answer and the identification information are acquired by a processor.

According to the present disclosure, there is provided a program for causing a computer to function as an information processing device including: a record control unit configured, in a case where information regarding a situation of a user is detected, to associate identification information with a predetermined section of conversation information with the user, and control recording of the identification information and the predetermined section; a transmission control unit configured to control transmission of the information regarding the situation of the user, and the identification information; and an output control unit configured, in a case where an answer to the information regarding the situation of the user, and the identification information are acquired, to control output of the predetermined section associated with the identification information, and output information corresponding to the answer.

### Advantageous Effects of Invention

As described above, according to the present disclosure, a technology that enables the user to easily recognize a situation to which output information provided to the user corresponds is provided. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram for describing an example of a function provided by an information processing device according to an embodiment of the present disclosure.

FIG. 2 is a diagram for describing another example of a function provided by an information processing device according to an embodiment of the present disclosure.

FIG. 3 is a diagram illustrating a functional configuration example of the information processing device.

FIG. 4 is a diagram illustrating a detailed configuration example of a control unit.

FIG. 5 is a diagram illustrating an example of a flow of a conversation performed between the information processing device and the user.

FIG. 6 is a flow chart illustrating an example of a flow of an operation of the information processing device.

FIG. 7 is a block diagram illustrating a hardware configuration example of the information processing device.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that, in the present specification and the drawings, structural elements that have substantially the same function and structure are sometimes distinguished from each other using different numbers after the same reference sign. However, when there is no need in particular to distinguish structural elements that have substantially the same function and structure, the same reference sign alone is attached.

Note that, the description is given in the following order.

1. Embodiment of present disclosure
1.1 Overview
1.2. Functional configuration example
1.3. Details of functions
1.4. Hardware configuration example

2. Conclusion

### 1. EMBODIMENT OF PRESENT DISCLOSURE

### 1.1 Overview

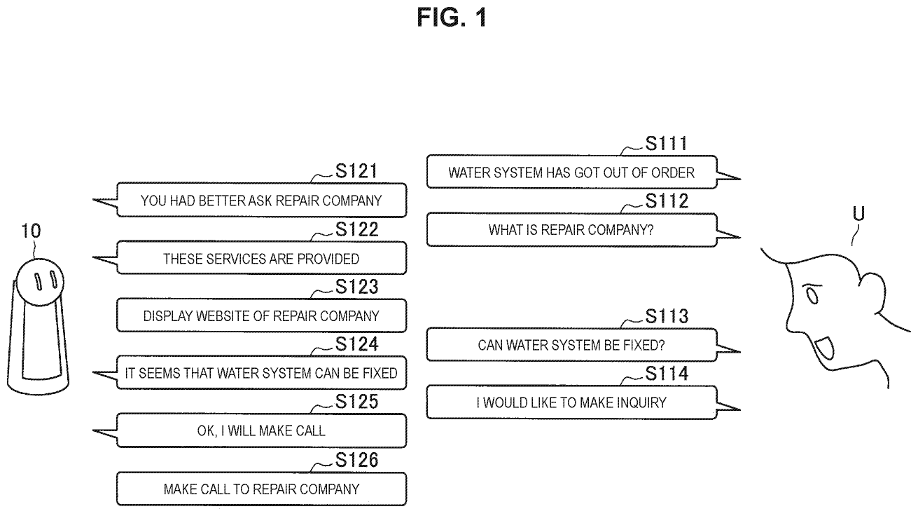

First, with reference to drawings, an overview of an information processing device according to an embodiment of the present disclosure will be described. FIG. 1 is a diagram for describing an example of a function provided by an information processing device according to an embodiment of the present disclosure. In this example, as illustrated in FIG. 1, an information processing device 10, a user U, and a repair company appear.

Note that, in the present specification, it is mainly assumed that the information processing device 10 functions as an agent. Here, the agent is a device configured to autonomously determine intention of the user U by interpreting input information of the user U, and control execution of a process based on the intention of the user U. In the present specification, it is assumed that the information processing device 10 is a robot, and sometimes the information processing device 10 is referred to as the agent.

There are various kinds of input information of the user U. For example, the input information includes information regarding a situation of the user U. In the present specification, the description will be given using a problem that the user U has (in the example illustrated in FIG. 1, such a problem that “a water system has got out of order”), as an example of information regarding the situation of the user U. For example, the information regarding the situation of the user U may include information regarding failures of goods or facilities. However, the information regarding the situation of the user U is not limited to the problem that the user U has. For example, the information regarding the situation of the user U may be a demand from the user U or may be a question from the user U. Alternatively, the information regarding the situation of the user U may be other information regarding the situation of the user U.

First of all, for solving a problem that the user U has, the information processing device 10 needs to detect the problem that the user U has. For example, in a case where the user U inputs, by gesture, a problem that the user U has, the problem that the user U has can be detected by an image recognition process performed on a captured image. In addition, in a case where the user U inputs, using the position of itself, a problem that the user U has, the problem that the user U has, the problem that the user U has can be detected by a distance between the information processing device 10 and the user U. In addition, in a case where the user U inputs, using voice, a problem that the user U has, the problem that the user U has, the problem that the user U has can be detected by a speech recognition process performed on collected sound information.

Note that, an operation performed by the information processing device 10 on input information input by the user U may be decided in any manner. As an example, input information input by the user U and an operation performed by the information processing device 10 may be associated with each other in advance, and registered in a database. In this case, the information processing device 10 is only required to acquire, from the database, an operation corresponding to input information input by the user U (e.g. an operation corresponding to or similar to the input information input by the user U). An operation performed by the information processing device 10 is not specifically limited. Assumed examples of the operation include output of output information corresponding to input information, transmission of a problem that the user U has, display of a website corresponding to input information, control of a process of making a call to other party corresponding to input information, and the like.

In addition, the information processing device 10 can identify the type of a problem by the analysis of the detected problem. For example, if the type of the problem is parts shortage, the information processing device 10 can cause the user U to browse a parts purchase website, or control a process of making a call to a parts sales company. In addition, if the type of the problem is failure of goods, the information processing device 10 can cause the user U to browse a website of a repair company of the goods, or control a process of making a call to a repair company of the goods.

Alternatively, an operation to be performed by the information processing device 10 may be narrowed down by a conversation (dialogue) performed between the information processing device 10 and the user U. For example, a conversation performed between the information processing device 10 and the user U for narrowing down an operation to be performed by the information processing device 10 may be patterned in advance. For example, if there is data in which problems that the user U has and sequences for solving the problems are collected, a conversation performed between the information processing device 10 and the user U for narrowing down an operation to be performed by the information processing device 10 can be patterned by the analysis of the data.

The description will now be given of an example in which an operation to be performed by the information processing device 10 is narrowed down by a conversation performed between the information processing device 10 and the user U. As an example, in a case where a water system of a house of the user U has got out of order, as illustrated in FIG. 1, the user U emits such voice that “a water system has got out of order” (S111). The information processing device 10 receives the voice as sound information, and outputs output information indicating that “you had better ask a repair company” that corresponds to the sound information, as voice (S121).

The user U hears the output information by voice, considers that he or she desires to know about a repair company, and emits such voice that “what is a repair company?” (S112). The information processing device 10 receives the voice as sound information, outputs output information indicating that “these services are provided” that corresponds to the sound information, as voice (S122), and performs “display of a website of the repair company” corresponding to the sound information (S123). Because the user U cannot identify whether the water system can be fixed, even if the user U views the website of the repair company, the user U emits such voice that “Can the water system be fixed?” (S113).

The information processing device 10 receives the voice as sound information, and outputs output information indicating that “it seems that the water system can be fixed” that corresponds to the sound information, as voice (S124). The user U hears the output information as voice, considers that he or she desires to know about the repair of the water system in more detail, and emits such voice that “I would like to make an inquiry” (S114). The information processing device 10 receives the voice as sound information, and outputs output information indicating that “OK, I will make a call” that corresponds to the sound information, as voice (S125). Furthermore, the information processing device 10 controls a telephone device such that “a call to the repair company” corresponding to the sound information is performed (S126).

As described with reference to FIG. 1, by the conversation performed with the user U, the information processing device 10 reaches such a conclusion that it is better to cause the user U to directly inquire of the repair company about the repair of the water system, for solving such a problem that “a water system has got out of order”. Then, for solving such a problem that “a water system has got out of order”, the information processing device 10 can decide an operation of controlling a process of making a call to a repair company.

Here, the information processing device 10 may operate so as to control a process of making a call to a repair company, and convey the conversation performed between the information processing device 10 and the user U, to the repair company as prior information. As a result, the user U is only required to talk with an answerer of the repair company using a telephone device, on the assumption that the conversation performed between the information processing device 10 and the user U is conveyed to the answerer of the repair company. This reduces the trouble of the user U.

In addition, FIG. 1 illustrates an example in which the information processing device 10 can instantly recognize that the repair company can repair the water system. On the other hand, for example, there can exist a repair company that had been unable to repair the water system in the beginning, but decides to handle the business of the repair of the water system after knowing the existence of the user U having the out-of-order water system (e.g. by service expansion). Thus, the information processing device 10 may notify the repair company of the existence of the user U having the out-of-order water system, and expect a possibility of being notified from the repair company later that the repair of the water system has become available.

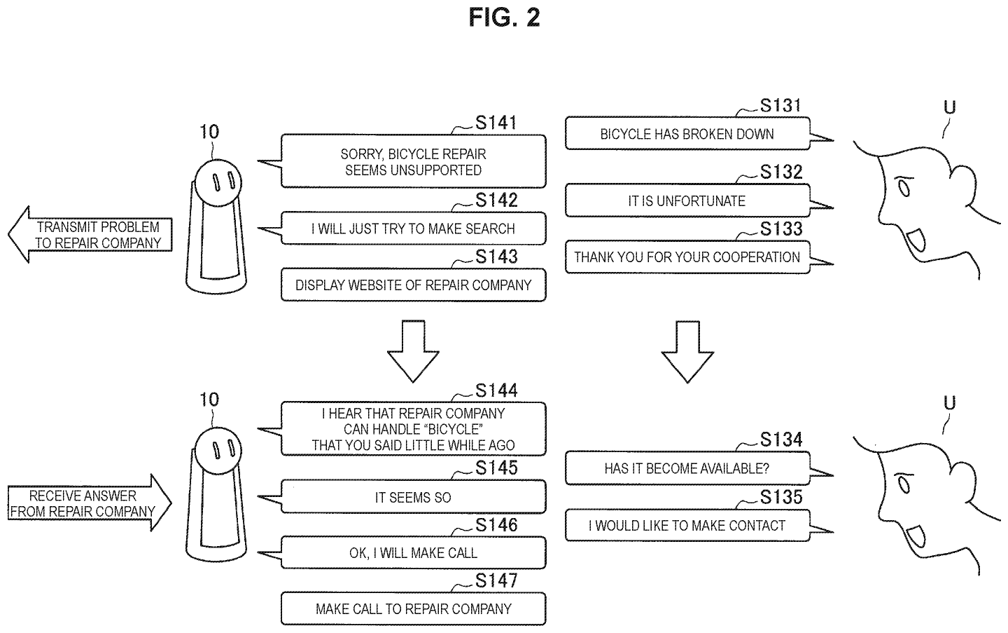

FIG. 2 is a diagram for describing another example of a function provided by the information processing device 10 according to an embodiment of the present disclosure. Also in this example, as illustrated in FIG. 2, the description will be given of an example in which the information processing device 10, the user U, and a repair company appear, and an operation to be performed by the information processing device 10 is narrowed down by a conversation performed between the information processing device 10 and the user U. Specifically, the description will be given of an example in which the repair company cannot repair a bicycle in the beginning, but decides to handle the business of bicycle repair after knowing the existence of the user U having a broken bicycle.

As an example, in a case where a bicycle of the user U has broken down, as illustrated in FIG. 2, the user U emits such voice that “a bicycle has broken down” (S131). The information processing device 10 receives the voice as sound information, and outputs output information indicating that “Sorry, bicycle repair seems unsupported” that corresponds to the sound information, as voice (S141). The user U hears the output information, by voice, and emits such voice that “it is unfortunate” (S132). The information processing device 10 receives the voice as sound information, and outputs output information indicating that “I will just try to make a search” that corresponds to the sound information, as voice (S142).

The user U hears the output information by voice, considers that he or she desires to know about a repair company that can perform bicycle repair, and emits such voice that “thank you for your cooperation” (S133). The information processing device 10 receives the voice as sound information, and displays a website of the repair company in response to the sound information (S143). Then, the information processing device 10 transmits, to the repair company, a problem that the user U has, that is, such a problem that “a bicycle has broken down”, with expecting a possibility of being notified from the repair company later that bicycle repair has become available (S151).

After that, the repair company decides to handle the business of bicycle repair after knowing the existence of the user U having “a broken bicycle”, and replies to the information processing device 10 that bicycle repair is available (S152). When the information processing device 10 receives the availability of bicycle repair from the repair company, the information processing device 10 outputs output information indicating that “I hear that the repair company can handle the “bicycle” that you said a little while ago”, as voice (S144). The user U hears the output information by voice, and emits such voice that “has it become available?” (S134).

The information processing device 10 receives the voice as sound information, and outputs output information indicating that “it seems so” that corresponds to the sound information, as voice (S145). The user U hears the output information by voice, and emits such voice that “I would like to make contact” (S135). The information processing device 10 receives the voice as sound information, and outputs output information indicating that “OK, I will make a call” that corresponds to the sound information, as voice (S146). Furthermore, the information processing device 10 controls a telephone device such that “a call to the repair company” corresponding to the sound information is performed (S147).

As described with reference to FIG. 2, by the conversation performed with the user U, the information processing device 10 reaches such a conclusion that it is better to cause the user U to directly inquire of the repair company about the bicycle repair, for solving such a problem that “a bicycle has broken down”. Then, for solving such a problem that “a bicycle has broken down”, the information processing device 10 can decide an operation of controlling a process of making a call to a repair company.

In addition, FIG. 2 illustrates an example in which the repair company decides to handle the business of bicycle repair after knowing the existence of the user U having “a broken bicycle”, and replies to the information processing device 10 that bicycle repair is available. Here, as illustrated in FIG. 2, if the bicycle of the user U is still broken when the information processing device 10 obtains the availability of bicycle repair from the repair company, there is a possibility that the user U asks the repair company for the repair of the bicycle (there is a possibility that the repair company is requested from the user U for bicycle repair).

On the other hand, even if the failure of the bicycle of the user U has been already fixed when the information processing device 10 obtains the availability of bicycle repair from the repair company, the fact that the repair company can repair a bicycle is conveyed to the user U. Thus, in a case where the bicycle breaks down again, the user U can request the repair company for bicycle repair (there is a possibility that the repair company is requested from the user U for bicycle repair).

With reference to FIG. 2, the description has been given of an example in which, in a case where a problem that the user U has is detected, the information processing device 10 transmits the problem that the user U has, to another information processing device. Here, times required until answers are obtained from other information processing devices are not uniform. Thus, there is a possibility that, when output information corresponding to an answer from the other information processing device is provided to the user U, the user U cannot easily recognize to which situation the output information corresponds. In the following description, a technology that enables the user U to easily recognize a situation to which output information provided to the user U corresponds will be mainly proposed. Note that, answers may include information for improving a problem that the user U has (situation of the user U).

### 1.2. Functional Configuration Example

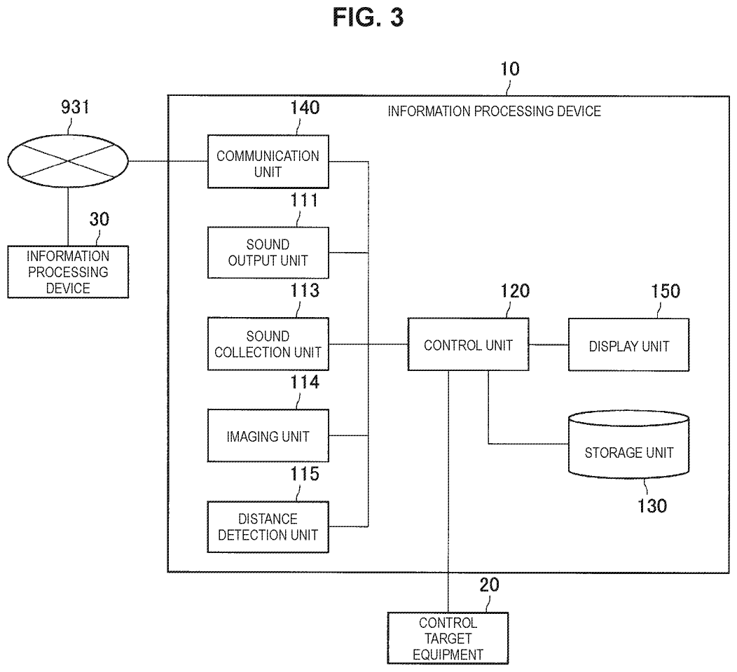

Next, a functional configuration example of the information processing device 10 will be described. FIG. 3 is a diagram illustrating the functional configuration example of the information processing device 10. As illustrated in FIG. 3, the information processing device 10 includes a sound output unit 111, a sound collection unit 113, an imaging unit 114, a distance detection unit 115, a control unit 120, a storage unit 130, a communication unit 140, and a display unit 150. The information processing device 10 and control target equipment 20 are capable of communicating with each other via a network (such as a wireless local area network (LAN)). In addition, the information processing device 10 is connected with a communication network 931, and can communicate with an information processing device 30 via the communication network 931. For example, the communication network 931 is implemented by the Internet.

The control target equipment 20 is equipment capable of accepting a command from the information processing device 10 and executing the command. Here, the type of the control target equipment 20 is not specifically limited. For example, the control target equipment 20 may be a telephone. In addition, as illustrated in FIG. 3, the control target equipment 20 may include a storage unit 230. The storage unit 230 may be implemented by, for example, a magnetic storage device, a semiconductor storage device, an optical storage device, or a magneto-optical storage device.

The sound output unit 111 has a function of outputting sound. For example, the sound output unit 111 includes a speaker. The sound is output through the speaker. The number of speakers included in the sound output unit 111 is not specifically limited as long as the number of speakers is one or more. In addition, positions of the one or more speakers included in the sound output unit 111 are not specifically limited. Note that, the sound output unit 111 may include a sound output device other than the speaker (such as earphones or headset) as long as the device has a sound outputting function.

The sound collection unit 113 has a function of acquiring sound through sound collection. For example, the sound collection unit 113 includes a microphone, and the sound is collected through the microphone. The number of microphones included in the sound collection unit 113 is not specifically limited as long as the number of microphones is one or more. In addition, positions of the one or more microphones included in the sound collection unit 113 are not specifically limited. Note that, the sound collection unit 113 may include a sound collection device other than the microphone as long as the device has a sound information collection function.

The imaging unit 114 has a function of inputting an image through image capturing. For example, the imaging unit 114 includes a camera, and an image captured by the camera is input. The number of cameras included in the imaging unit 114 is not specifically limited as long as the number of cameras is one or more. In addition, positions of the one or more cameras included in the imaging unit 114 are not specifically limited. In addition, the one or more cameras may include a monocular camera, or may include a stereo camera.

The distance detection unit 115 has a function of detecting a distance to a user U. For example, the distance detection unit 115 includes a ranging sensor, and acquires a distance to a user U detected by the ranging sensor. A position of the ranging sensor is not specifically limited. In addition, the type of the ranging sensor is not specifically limited. For example, the distance sensor may be an infrared distance sensor or may be an ultrasonic distance sensor.

The communication unit 140 has functions of acquiring data from the information processing device 30 connected with the communication network 931 and writing data to the information processing device 30 via the communication network 931. For example, the communication unit 140 is implemented by a communication interface. Note that, the number of the information processing devices 30 connected with the communication network 931 may be one or more.

The storage unit 130 is a storage medium configured to store programs to be executed by the control unit 120 and store data necessary for executing the programs. In addition, the storage unit 130 temporarily stores data for computation to be performed by the control unit 120. The storage unit 130 may be implemented by a magnetic storage unit device, a semiconductor storage device, an optical storage device, a magneto-optical storage device, or the like.

The display unit 150 has a function of displaying various kinds of screens. In this embodiment, it is mainly assumed that the display unit 150 is a projector. However, the type of the display unit 150 is not limited. For example, the display unit 150 may be a liquid crystal display or an organic electro-luminescence (EL) display as long as the display unit 150 is a display capable of displaying screens that are visible by users. In addition, in this embodiment, it is assumed that the display unit 150 displays a screen at a relatively high position (such as a wall) or at a relatively low position (such as a body of the agent or a place near hands of a user). However, the position at which the display unit 150 displays a screen is not limited.

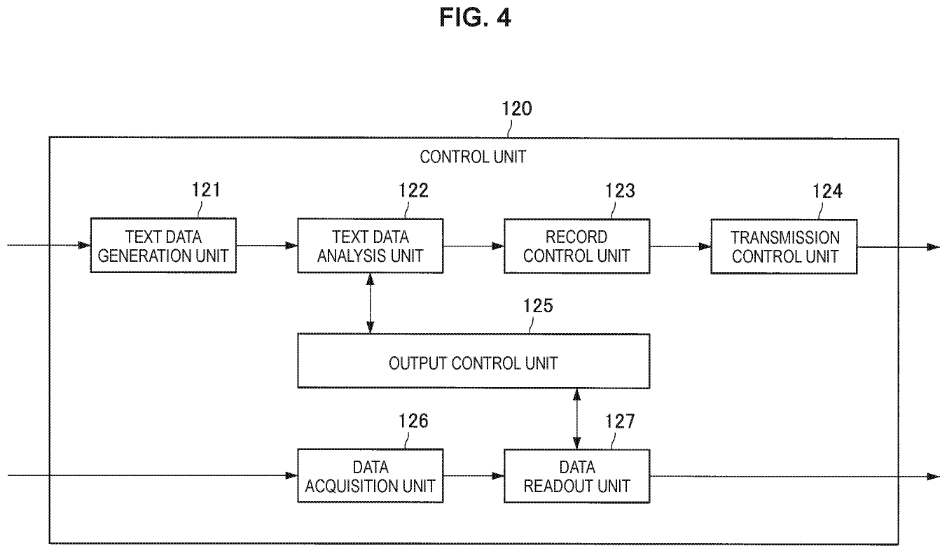

The control unit 120 controls the respective units in the information processing device 10. FIG. 4 is a diagram illustrating a detailed configuration example of the control unit 120. As illustrated in FIG. 4, the control unit 120 includes a text data generation unit 121, a text data analysis unit 122, a record control unit 123, a transmission control unit 124, an output control unit 125, a data acquisition unit 126, and a data readout unit 127. Details of these functional blocks will be described later. Note that, for example, the control unit 120 may be implemented by a central processing unit (CPU) or the like. In the case where the control unit 120 is implemented by a processing device such as the CPU, the processing device may be implemented by an electronic circuit.

Note that, hereinafter, the wording “voice” (or “speech”) and the wording “sound” are used differently. Specifically, with regard to sound collected by the sound collection unit 113, the “voice” and the “speech” mainly mean speech from a user U. In addition, the wording “voice” (or “speech”) mainly means speech performed by the information processing device 10, among sounds output from the information processing device 10. The wording “sound” includes a sound emitted from an object, and the like, aside from the speech from the user U and the speech performed by the information processing device 10.

The functional configuration example of the information processing device 10 according to the present embodiment has been described above.

### 1.3. Details of Functions

Subsequently, the details of functions of the information processing device 10 will be described. In the following description, the information processing device 30 is assumed to be a terminal used by an answerer of a repair company. Nevertheless, the information processing device 30 needs not be a terminal used by an answerer of a repair company. For example, the information processing device 30 can be used by any person that can make an answer to a problem that the user U has. In addition, in the following description, it is assumed that an answerer of a repair company makes an answer to a problem that the user U has, that is to say, such a problem that “a door of a house has broken down”.

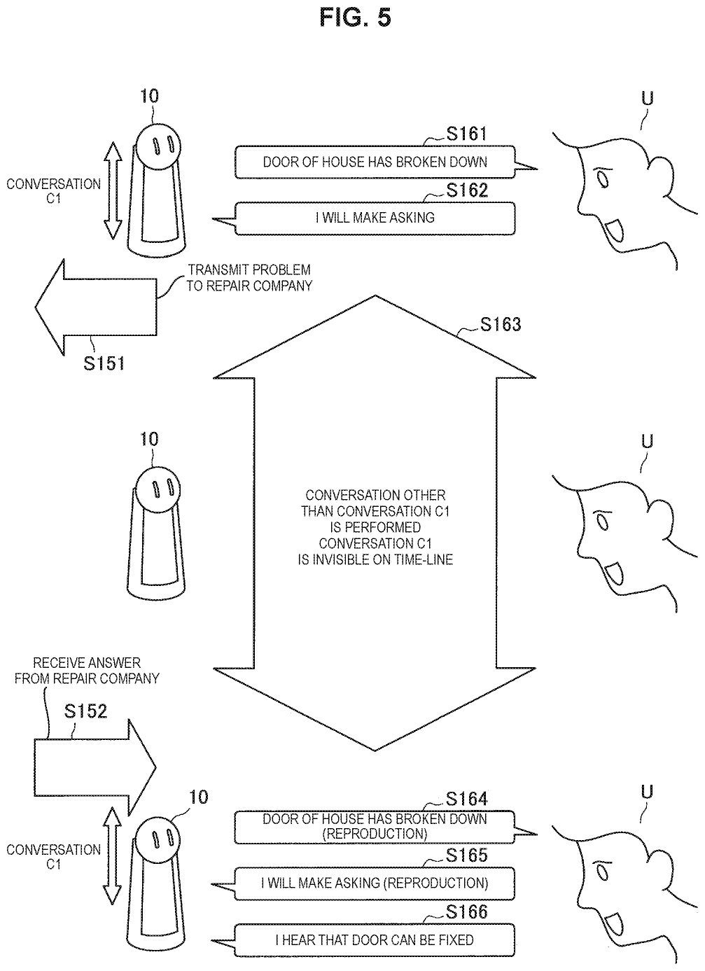

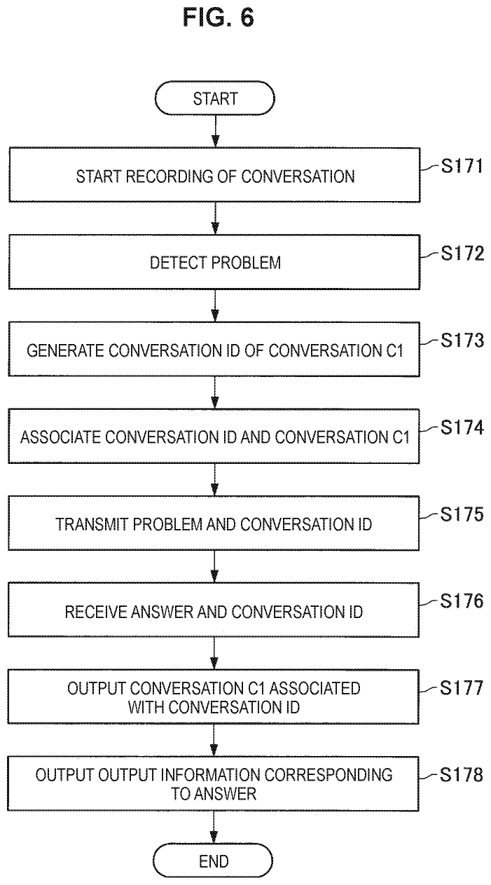

FIG. 5 is a diagram illustrating an example of a flow of a conversation performed between the information processing device 10 and the user U. In addition, FIG. 6 is a flow chart illustrating an example of a flow of an operation of the information processing device 10. As illustrated in FIG. 5, a conversation can be performed between the information processing device 10 and the user U. The record control unit 123 starts recording the conversation performed between the information processing device 10 and the user U on the storage unit 130 as conversation information (S171).

More specifically, the conversation information may include first text data (content of speech performed by the user U) obtained by a speech recognition process performed by the text data generation unit 121 that is based on sound information collected by the sound collection unit 113. In addition, the conversation information may include second text data (content of speech performed by the information processing device 10) provided to the user U in accordance with an analysis result of the first text data (e.g. second text data registered in a database with being associated with the first text data in advance).

Here, the speech recognition process performed by the text data generation unit 121 may be directly performed on the sound information collected by the sound collection unit 113, or may be performed on sound information obtainable after a process of some sort (e.g. noise reduction, etc.) is performed on the sound information collected by the sound collection unit 113.

When the user U faces such a problem that a door of a house has broken down, the user U emits such voice that “a door of a house has broken down” (S161). In the information processing device 10, the sound collection unit 113 receives the voice as sound information, and the text data generation unit 121 generates text data “a door of a house has broken down” by the speech recognition process that is based on the sound information.

Subsequently, by analyzing the text data “a door of a house has broken down”, the text data analysis unit 122 detects the problem that the user U has “a door has broken down” (S172). For example, it is assumed that a combination of a noun “door”, a verb “broken down”, and a problem “a door has broken down” is pre-registered in a database. In this case, the text data analysis unit 122 is only required to detect the problem that the user U has “a door has broken down”, by acquiring the problem “a door has broken down” corresponding to the noun “door” and the verb “broken down” that are included in the generated text data “a door of a house has broken down”.

In addition, an operation of the information processing device 10 “output of output information indicating that “I will make asking”” may also be registered in the database in association with the problem “a door has broken down”. In other words, the output control unit 125 may control “output of output information indicating that “I will make asking”” corresponding to the sound information “a door of a house has broken down” (S162).

Note that, here, it is assumed that the output information includes voice information (e.g. voice information obtained by reading out text data, etc.), and the output control unit 125 controls the sound output unit 111 such that the voice information is output by the sound output unit 111. Nevertheless, the output information needs not include voice information. For example, the output information may include display information (e.g. character string corresponding to text data, etc.), and the output control unit 125 may control the display unit 150 such that the display information is output by the display unit 150.

On the other hand, the record control unit 123 generates identification information (hereinafter, also referred to as a “conversation ID”.) for a predetermined section of the conversation information (S173). The conversation ID is generated so as to be uniquely allocated to a section of the conversation information. Here, the predetermined section of the conversation information may include at least a speech sentence of the user U “a door of a house has broken down” in the conversation information that is spoken when the problem that the user U has is detected. Furthermore, the predetermined section of the conversation information may further include a response sentence “I will make asking” corresponding to the speech sentence of the user U that is spoken when the problem that the user U has is detected.

In the example illustrated in FIGS. 5 and 6, the record control unit 123 sets the speech sentence of the user U “a door of a house has broken down” and the response sentence “I will make asking” corresponding to the speech sentence of the user U, as the predetermined section of the conversation information, and associates a conversation ID with the predetermined section (hereinafter, also referred to as a “conversation C1”.) (S174). In addition, the record control unit 123 controls the recording of the conversation ID into the storage unit 130.

In addition, an operation of the information processing device 10 “transmission of the problem to the repair company” may also be registered in the database in association with the problem “a door has broken down”. In other words, the transmission control unit 124 controls the transmission of the problem that the user U has “a door has broken down”, and the conversation ID, to the information processing device 30 (S151, S175). Subsequently, in the information processing device 30 used by the answerer of the repair company, the problem that the user U has “a door has broken down”, and the conversation ID are received.

The answerer confirms the problem that the user U has “a door has broken down”, but cannot reply to the information processing device 10 that door repair is available because the repair company does not handle the business of door repair at the time point. After that, a conversation other than the conversation C1 is performed between the information processing device 10 and the user U. Thus, the conversation C1 enters a state of being invisible on a time-line (S163). Here, it is assumed that the repair company decides to handle the business of door repair after knowing the existence of the user U having a broken door.

Subsequently, in the information processing device 10, the communication unit 140 receives an answer “a door can be fixed” indicating that the problem that the user U has “a door has broken down” can be solved (an answer indicating that the situation of the user U can be changed), and the conversation ID (S152, S176), and the data acquisition unit 126 acquires the answer “a door can be fixed” indicating that the problem that the user U has “a door has broken down” can be solved, and the conversation ID. In a case where the answer “a door can be fixed” indicating that the problem that the user U has “a door has broken down” can be solved, and the conversation ID are acquired by the data acquisition unit 126, the data readout unit 127 reads out, from the storage unit 130, the conversation C1 associated with the conversation ID.

Furthermore, in a case where the answer “a door can be fixed” indicating that the problem that the user U has “a door has broken down” can be solved, and the conversation ID are acquired by the data acquisition unit 126, the output control unit 125 controls output of the conversation C1 “a door of a house has broken down” “I will make asking” that is associated with the conversation ID (S164, S165, S177). In addition, the output control unit 125 controls output of output information corresponding to the answer “the door can be fixed” (S178).

For example, the output control unit 125 may generate output information “I hear that the door can be fixed” by the modification of adding “I hear that” to the beginning of the answer “the door can be fixed” (S166). Alternatively, the output control unit 125 may generate output information by performing another modification on the answer “the door can be fixed”, or may directly use the answer “the door can be fixed” as the output information.

Note that, here, it is also assumed that the output information includes voice information (e.g. voice information obtained by reading out text data, etc.), and the output control unit 125 controls the sound output unit 111 such that the voice information is output by the sound output unit 111. Nevertheless, the output information needs not include voice information. For example, the output information may include display information (e.g. character string corresponding to text data, etc.), and the output control unit 125 may control the display unit 150 such that the display information is output by the display unit 150.

As described above, in a case where a problem that the user U has is detected, the information processing device 10 associates a conversation ID with a predetermined section (conversation C1) of conversation information of the user U and the information processing device 10, and controls the transmission of the problem that the user U has, and the conversation ID, to the information processing device 30. Then, in a case where an answer indicating that the problem that the user U has can be solved, and the conversation ID are received, the information processing device 10 controls output of the predetermined section (conversation C1) associated with the conversation ID, and output information corresponding to the answer.

According to this configuration, in a case where the answer indicating that the problem that the user U has can be solved is obtained from the information processing device 30, not only the output information corresponding to the answer is output, but also the predetermined section (conversation C1) of the conversation information of the user U and the information processing device 10 is output. This enables the user U to easily recognize a situation to which the output information provided to the user U corresponds.

### 1.4. Hardware Configuration Example

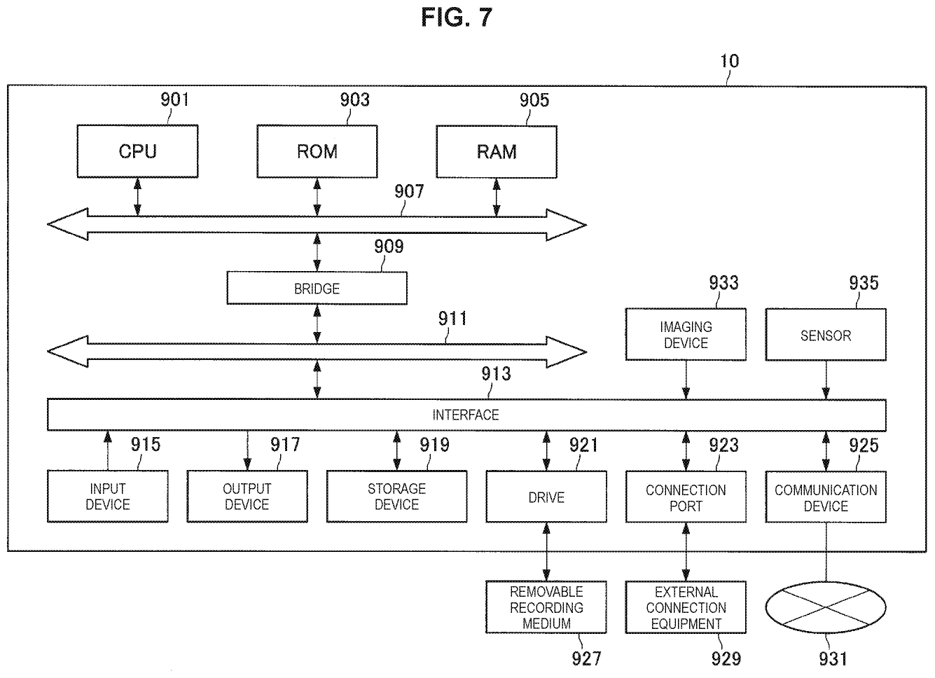

Next, with reference to FIG. 7, a hardware configuration of the information processing device 10 according to the embodiment of the present disclosure will be described. FIG. 7 is a block diagram illustrating the hardware configuration example of the information processing device 10 according to the embodiment of the present disclosure.

As illustrated in FIG. 7, the information processing device 10 includes a central processing unit (CPU) 901, read only memory (ROM) 903, and random access memory (RAM) 905. In addition, the information processing device 10 may include a host bus 907, a bridge 909, an external bus 911, an interface 913, an input device 915, an output device 917, a storage device 919, a drive 921, a connection port 923, and a communication device 925. Moreover, the information processing device 10 may include an imaging device 933 and a sensor 935, as necessary. The information processing device 10 may include a processing circuit such as a digital signal processor (DSP) or an application specific integrated circuit (ASIC), alternatively or in addition to the CPU 901.

The CPU 901 serves as an arithmetic processing device and a control device, and controls the overall operation or a part of the operation of the information processing device 10 according to various programs recorded in the ROM 903, the RAM 905, the storage device 919, or a removable recording medium 927. The ROM 903 stores programs, operation parameters, and the like used by the CPU 901. The RAM 905 temporarily stores programs used when the CPU 901 is executed, and parameters that change as appropriate when executing such programs. The CPU 901, the ROM 903, and the RAM 905 are connected with each other via the host bus 907 configured from an internal bus such as a CPU bus. In addition, the host bus 907 is connected to the external bus 911 such as a Peripheral Component Interconnect/Interface (PCI) bus via the bridge 909.

The input device 915 is a device operated by a user such as a mouse, a keyboard, a touchscreen, a button, a switch, and a lever. The input device 915 may include a microphone configured to detect voice of users. The input device 915 may be a remote control device that uses, for example, infrared radiation and another type of radio waves. Alternatively, the input device 915 may be external connection equipment 929 such as a mobile phone that corresponds to an operation of the information processing device 10. The input device 915 includes an input control circuit that generates input signals on the basis of information which is input by a user to output the generated input signals to the CPU 901. A user inputs various types of data and indicates a processing operation to the information processing device 10 by operating the input device 915. In addition, the imaging device 933 (to be described later) may function as the input device by capturing an image of movement of hands of a user or capturing a finger of a user. In this case, a pointing position may be decided in accordance with the movement of the hands or a direction of the finger.

The output device 917 includes a device that can visually or audibly report acquired information to a user. The output device 917 may be, for example, a display device such as a liquid crystal display (LCD), a plasma display panel (PDP), an organic electro-luminescence (EL) display, a projector, or a hologram display device, an audio output device such as a speaker or a headphone, or a printer. The output device 917 outputs a result obtained through a process performed by the information processing device 10, in the form of text or video such as an image, or sounds such as voice and audio sounds. In addition, the output device 917 may include a light or the like to light the surroundings.

The storage device 919 is a device for data storage that is an example of the storage unit of the information processing device 10. The storage device 919 includes, for example, a magnetic storage unit device such as a hard disk drive (HDD), a semiconductor storage device, an optical storage device, or a magneto-optical storage device. The storage device 919 stores therein various data and programs executed by the CPU 901, and various data acquired from an outside.

The drive 921 is a reader/writer for the removable recording medium 927 such as a magnetic disk, an optical disc, a magneto-optical disk, and a semiconductor memory, and built in or externally attached to the information processing device 10. The drive 921 reads out information recorded on the mounted removable recording medium 927, and outputs the information to the RAM 905. The drive 921 writes the record into the mounted removable recording medium 927.

The connection port 923 is a port used to directly connect equipment to the information processing device 10. The connection port 923 may be a USB (Universal Serial Bus) port, an IEEE1394 port, and a Small Computer System Interface (SCSI) port, or the like. In addition, the connection port 923 may be an RS-232C port, an optical audio terminal, an HDMI (registered trademark) (High-Definition Multimedia Interface) port, and so on. The connection of the external connection equipment 929 to the connection port 923 makes it possible to exchange various kinds of data between the information processing device 10 and the external connection equipment 929.

The communication device 925 is a communication interface including, for example, a communication device for connection to the communication network 931. The communication device 925 may be, for example, a wired or wireless local area network (LAN), Bluetooth (registered trademark), or a communication card for a wireless USB (WUSB). The communication device 925 may also be, for example, a router for optical communication, a router for asymmetric digital subscriber line (ADSL), or a modem for various types of communication. For example, the communication device 925 transmits and receives signals in the Internet or transmits signals to and receives signals from another communication device by using a predetermined protocol such as TCP/IP. The communication network 931 to which the communication device 925 connects is a network established through wired or wireless connection. The communication network 931 is, for example, the Internet, a home LAN, infrared communication, radio communication, or satellite communication.

The imaging device 933 is a device that captures images of a real space by using an image sensor such as a charge coupled device (CCD) or a complementary metal oxide semiconductor (CMOS), and various members such as a lens for controlling image formation of a subject image onto the image sensor, and generates the captured images. The imaging device 933 may capture a still image or a moving image.

The sensor 935 is various sensors such as a ranging sensor, an acceleration sensor, a gyro sensor, a geomagnetic sensor, an optical sensor, and a sound sensor. The sensor 935 acquires information regarding a state of the information processing device 10 such as a posture of a housing of the information processing device 10, and information regarding an environment surrounding the information processing device 10 such as luminous intensity and noise around the information processing device 10. The sensor 935 may include a global positioning system (GPS) sensor that receives GPS signals to measure latitude, longitude, and altitude of the device.

### 2. CONCLUSION

As described above, according to the embodiment of the present disclosure, there is provided the information processing device 10 including the record control unit 123 that, in a case where information regarding a situation of a user is detected, associates identification information with a predetermined section of conversation information with the user, and controls recording of the identification information, the transmission control unit 124 that controls transmission of the information regarding the situation of the user, and the identification information, and the output control unit 125 that, in a case where an answer to the information regarding the situation of the user, and the identification information are acquired, controls output of the predetermined section associated with the identification information, and output information corresponding to the answer.

According to this configuration, in a case where the answer to the information regarding the situation of the user is obtained from the information processing device 30, not only the output information corresponding to the answer is output, but also the predetermined section of the conversation information of the user U and the information processing device 10 is output. This enables the user to easily recognize a situation to which output information provided to the user corresponds.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, the positions of the respective structural elements are not specifically limited as long as the above-described operation of the information processing device 10 is achieved. As a specific example, the text data generation unit 121, the text data analysis unit 122, and the like may be provided in a server (not illustrated) connected via a communication network 931. In other words, the information processing device 10 may be implemented by using so-called cloud computing. In this case, the information processing device 10 corresponds to a client connected with the server via the communication network 931. The text data generation unit 121, the text data analysis unit 122, and the like may be installed in different servers.

Alternatively, one of the text data generation unit 121 and the text data analysis unit 122 may be installed in the server (not illustrated), and the other of the text data generation unit 121 and the text data analysis unit 122 may be installed in hardware of the client. Alternatively, the information processing device 10 may be implemented by the text data generation unit 121 and the text data analysis unit 122 that are installed in the server (not illustrated), and the information processing device 10 does not have to include the other structural elements.

In addition, it is also possible to create a computer program for causing hardware such as CPU, ROM, and RAM, which are embedded in a computer, to execute functions equivalent to the functions of the control unit 120. Moreover, it may be possible to provide a computer-readable recording medium having the program recorded thereon.

The situation of the user may be identified by a partner on a telephone. For example, the situation of the user may be identified by a telephone number of the partner. In addition, the information regarding the situation of the user may be identified from a conversation performed on a telephone. For example, only a conversation regarding a specific topic may be extracted from the conversation performed on the telephone, and associated with each other. The conversation associated with the specific topic in this manner may be appropriately provided to the user as a past dialogue.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing device including:

a record control unit configured, in a case where information regarding a situation of a user is detected, to associate identification information with a predetermined section of conversation information with the user, and control recording of the identification information;

a transmission control unit configured to control transmission of the information regarding the situation of the user, and the identification information; and

an output control unit configured, in a case where an answer to the information regarding the situation of the user, and the identification information are acquired, to control output of the predetermined section associated with the identification information, and output information corresponding to the answer.

(2)

The information processing device according to (1), in which the predetermined section includes at least a speech sentence of the user in the conversation information that is spoken when the information regarding the situation of the user is detected.

(3)

The information processing device according to (2), in which the predetermined section further includes a response sentence corresponding to the speech sentence of the user that is spoken when the information regarding the situation of the user is detected.

(4)

The information processing device according to any one of (1) to (3), in which the output information includes voice information, and the output control unit controls a sound output unit such that the voice information is output by the sound output unit.

(5)

The information processing device according to any one of (1) to (4), in which the output information includes display information, and the output control unit controls a display unit such that the display information is output by the display unit.

(6)

The information processing device according to any one of (1) to (5), in which the conversation information includes first text data obtained by a speech recognition process that is based on collected sound information, and second text data provided to the user in accordance with an analysis result of the first text data.

(7)

The information processing device according to (6), including:

a text data generation unit configured to generate the first text data by the speech recognition process that is based on the sound information.

(8)

The information processing device according to (6) or (7), including:

a text data analysis unit configured to detect the information regarding the situation of the user, by analyzing the first text data.

(9)

The information processing device according to any one of (1) to (8), including: a data acquisition unit configured to acquire the answer to the information regarding the situation of the user, and the identification information, via a communication unit.

(10)

The information processing device according to any one of (1) to (9), including: a data readout unit configured, in a case where the answer to the information regarding the situation of the user, and the identification information are acquired, to read out the predetermined section associated with the identification information.

(11)

The information processing device according to any one of (1) to (10), in which the information regarding the situation of the user includes information regarding a failure of goods or a facility.

(12)

The information processing device according to any one of (1) to (11), in which the answer to the information regarding the situation of the user includes information for improving the situation of the user.

(13)

An information processing method including:

associating identification information with a predetermined section of conversation information with a user, and controlling recording of the identification information in a case where information regarding a situation of the user is detected;

controlling transmission of the information regarding the situation of the user, and the identification information; and

controlling output of the predetermined section associated with the identification information, and output information corresponding to an answer to the information regarding the situation of the user, in a case where the answer and the identification information are acquired by a processor.

(14)

A program for causing a computer to function as an information processing device including:

a record control unit configured, in a case where information regarding a situation of a user is detected, to associate identification information with a predetermined section of conversation information with the user, and control recording of the identification information;

a transmission control unit configured to control transmission of the information regarding the situation of the user, and the identification information; and

an output control unit configured, in a case where an answer to the information regarding the situation of the user, and the identification information are acquired, to control output of the predetermined section associated with the identification information, and output information corresponding to the answer.

### REFERENCE SIGNS LIST

10 information processing device
111 sound output unit
113 sound collection unit
114 imaging unit
115 distance detection unit
120 control unit
121 text data generation unit
122 text data analysis unit
123 record control unit
124 transmission control unit
125 output control unit
126 data acquisition unit
127 data readout unit
130 storage unit
140 communication unit
150 display unit
20 control target equipment
230 storage unit
30 information processing device (another information processing device)

1. An information processing device comprising:
a record control unit configured, in a case where information regarding a situation of a user is detected, to associate identification information with a predetermined section of conversation information with the user, and control recording of the identification information;
a transmission control unit configured to control transmission of the information regarding the situation of the user, and the identification information; and
an output control unit configured, in a case where an answer to the information regarding the situation of the user, and the identification information are acquired, to control output of the predetermined section associated with the identification information, and output information corresponding to the answer.

2. The information processing device according to claim 1, wherein the predetermined section includes at least a speech sentence of the user in the conversation information that is spoken when the information regarding the situation of the user is detected.

3. The information processing device according to claim 2, wherein the predetermined section further includes a response sentence corresponding to the speech sentence of the user that is spoken when the information regarding the situation of the user is detected.

4. The information processing device according to claim 1, wherein the output information includes voice information, and
the output control unit controls a sound output unit such that the voice information is output by the sound output unit.

5. The information processing device according to claim 1, wherein the output information includes display information, and
the output control unit controls a display unit such that the display information is output by the display unit.

6. The information processing device according to claim 1, wherein the conversation information includes first text data obtained by a speech recognition process that is based on collected sound information, and second text data provided to the user in accordance with an analysis result of the first text data.

7. The information processing device according to claim 6, comprising:
a text data generation unit configured to generate the first text data by the speech recognition process that is based on the sound information.

8. The information processing device according to claim 6, comprising:
a text data analysis unit configured to detect the information regarding the situation of the user, by analyzing the first text data.

9. The information processing device according to claim 1, comprising:
a data acquisition unit configured to acquire the answer to the information regarding the situation of the user, and the identification information, via a communication unit.

10. The information processing device according to claim 1, comprising:
a data readout unit configured, in a case where the answer to the information regarding the situation of the user, and the identification information are acquired, to read out the predetermined section associated with the identification information.

11. The information processing device according to claim 1, wherein the information regarding the situation of the user includes information regarding a failure of goods or a facility.

12. The information processing device according to claim 1, wherein the answer to the information regarding the situation of the user includes information for improving the situation of the user.

13. An information processing method comprising:
associating identification information with a predetermined section of conversation information with a user, and controlling recording of the identification information and the predetermined section in a case where information regarding a situation of the user is detected;
controlling transmission of the information regarding the situation of the user, and the identification information; and
controlling output of the predetermined section associated with the identification information, and output information corresponding to an answer to the information regarding the situation of the user, in a case where the answer and the identification information are acquired by a processor.

14. A program for causing a computer to function as an information processing device comprising:
a record control unit configured, in a case where information regarding a situation of a user is detected, to associate identification information with a predetermined section of conversation information with the user, and control recording of the identification information;
a transmission control unit configured to control transmission of the information regarding the situation of the user, and the identification information; and
an output control unit configured, in a case where an answer to the information regarding the situation of the user, and the identification information are acquired, to control output of the predetermined section associated with the identification information, and output information corresponding to the answer.
